(19) United States
(12) Patent Application Publication
(10) Pub. No.: US 2023/0255841 A1
(43) Pub. Date: Aug. 17, 2023

(54) Orbit Sleep Bed

(71) Applicant: Justin Wiler, Dripping Springs, TX (US)

(72) Inventor: Justin Wiler, Dripping Springs, TX (US)

(21) Appl. No.: 17/672,544

(22) Filed: Feb. 15, 2022

(51) Int. Cl. A61G 7/008; A61G 7/018; A61G 7/00; A47C 19/02

(52) U.S. Cl. CPC A61G 7/008; A47C 19/021; A61G 7/001; A61G 7/018

(57) ABSTRACT

A system and method for providing an Orbit Sleep Concept Bed according to the present invention includes a rotating bed platform for slowly rotating from side to side to continually reposition during a sleep period, a motor and controller box coupled to the rotating bed platform for rotating the bed platform from side to side to continually reposition during a sleep period, and a base having a pair of side supports and connecting side members supporting the rotating bed. The rotating bed platform includes a platform bed, a top and bottom connection rails running along a length of the platform bed, a set of strap/hammock about an inner side of the platform bed, a thin foam mattress having a thin foam base and a partial foam base, a pair of guide rails along an outer side of the platform bed, each of the pair of guide rails resting upon a set of roller supports coupled to each end of the side supports of the base, and a drive strap coupled to top and bottom rails and engaging the motor and controller box to move the platform bed.

### TECHNICAL FIELD

This application relates in general to a system and method for providing a sleeping aid device, and more specifically, to a system and method for providing an Orbit Sleep Concept Bed.

### BACKGROUND

Many people experience a number of health conditions that are exacerbated by difficulty in sleeping soundly and becoming fully rested. Many of these conditions are reduced if individuals do not sleep in a single, or small number of positions causing their full body weight to be supported by just a few body locations. By gently and slowly altering an individual’s sleeping position, a sound and restful sleep period may be experienced by these individuals.

Therefore, a need exists for a system and method for providing an Orbit Sleep Concept Bed. The present invention attempts to address the limitations and deficiencies in prior solutions according to the principles and example embodiments disclosed herein.

### SUMMARY

In accordance with the present invention, the above and other problems are solved by providing a system and method for providing an Orbit Sleep Concept Bed according to the principles and example embodiments disclosed herein.

In one embodiment, the present invention is a system for providing an Orbit Sleep Concept Bed. The rotating bed platform includes a rotating bed platform for slowly rotating from side to side to continually reposition during a sleep period, a motor and controller box coupled to the rotating bed platform for rotating the bed platform from side to side to continually reposition during a sleep period, and a base having a pair of side supports and connecting side members supporting the rotating bed.

According to another aspect of the present invention, the rotating bed platform includes a platform bed, a top and bottom connection rails running along a length of the platform bed, a set of strap/hammock about an inner side of the platform bed, a thin foam mattress having a thin foam base and a partial foam base, a pair of guide rails along an outer side of the platform bed, each of the pair of guide rails resting upon a set of roller supports coupled to each end of the side supports of the base, and a drive strap coupled to top and bottom rails and engaging the motor and controller box to move the platform bed.

According to another aspect of the present invention, the motor and controller box includes a motor coupled to a spindle by a drive line, the drive strap being configured around the spindle such that rotation caused by the motor causes the drive strap to rotate the bed platform, and a set of electrical components. The set of electrical components include a programmable controller, a Bluetooth transceiver, a power supply, a motor power supply, and a relay device for controllably connecting the motor power supply to the motor.

According to another aspect of the present invention, the programmable controller includes a memory having instructions stored thereon, and a processor configured to execute a set of software components on the memory to cause the programmable controller to rotate the bed platform according to a user defined program. The set of software components comprise an app controller, a network interface, a Bluetooth™ interface communicatively connected to the Bluetooth transceiver, a user interface coupled to a touch screen display, a user command processor, and a local datastore.

According to another aspect of the present invention, the motor is powered by a powerline generated by the motor power supply and also receives a set of motor control signals from the programmable controller to activate the operation of the motor, and the motor must receive both an active powerline and the set of motor control signals to operate, the motor control signals comprises both a motor enable signal and a motor speed signal.

According to another aspect of the present invention, the motor speed signal comprises a DC voltage value that corresponds to a desired speed of the motor.

According to another aspect of the present invention, the motor speed signal comprises an encoded set of signal values that corresponds to one of a plurality of desired speed of the motor.

According to another aspect of the present invention, the programmable controller causes the platform bed to rotate between a left position, a right position, and a center position, the programmable controller causes the platform bed to pause at each of the left position, the right position, and the center position for a corresponding delay period of time before moving to a next position.

According to another aspect of the present invention, the left position uses a left delay time period, the right position uses a right delay time period, and the center position uses a center delay time period.

According to another aspect of the present invention, a smartphone coupled to the programmable controller via a Bluetooth connection to permit a user program the user program defines the sequence of positions that the bed platform rotates to before each delay time period, the left position, the left delay time period, the right position, a right delay time period, the center position, the center delay time period, and a speed of rotation.

In another embodiment, the present invention is a method for providing an Orbit Sleep Concept Bed. The method comprising accepts a user program defining the sequence of positions that the bed platform rotates to before a delay time period, rotates the bed platform to a first position of the user program, waits the delay time period, and rotates the bed platform to a next position of the user program until the user program ends.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Referring now to the drawings in which like reference numbers represent corresponding parts throughout:

FIG. 1 illustrates a front view of a system for providing an Orbit Sleep Concept Bed according to the present invention.

FIG. 2 illustrates a rear view of a system for providing an Orbit Sleep Concept Bed according to the present invention.

FIG. 3 illustrates a front, perspective view of a system for providing an Orbit Sleep Concept Bed according to the present invention.

FIG. 4 illustrates a cross section view of a system for providing an Orbit Sleep Concept Bed according to the present invention.

FIG. 5 illustrates another side view of a system for providing an Orbit Sleep Concept Bed according to the present invention.

FIGS. 6a-e illustrate the motor and roller components of a system for providing an Orbit Sleep Concept Bed according to the present invention.

FIG. 7 illustrates electrical components within the user removable motor and controller box of the system for providing an Orbit Sleep Concept Bed according to the present invention.

FIGS. 8a-c illustrate a computing system for providing an Orbit Sleep Concept Bed including a set of software components, a mobile application, and a generalized schematic of a programmable processing system utilized as the various computing components described herein used to implement an embodiment of the present invention.

### DETAILED DESCRIPTION

This application relates in general to a system and method for providing a sleeping aid device, and more specifically, to a system and method for providing an Orbit Sleep Concept Bed according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “individual” and “user” refer to an entity, e.g., a human, using an article of manufacture for providing an Orbit Sleep Concept Bed according to the present invention. The term user herein refers to one or more users.

The term “invention” or “present invention” refers to the invention being applied for via the patent application with the title “Orbit Sleep Concept Bed.” Invention may be used interchangeably with bed.

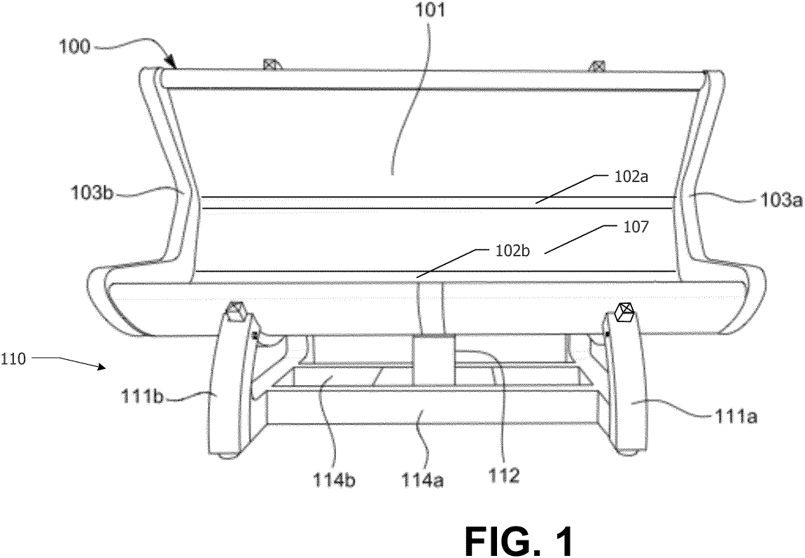

In general, the present disclosure relates to a system for providing an Orbit Sleep Concept Bed according to the present invention. To better understand the present invention, FIG. 1 illustrates a front view of a system for providing an Orbit Sleep Concept Bed according to the present invention. An Orbit Concept bed 100 includes a rotating bed platform 101 having enclosing sides 103a-b. The rotating bed platform 101 rests on top of a base 110 having a pair of side supports 111a-b and connecting support members 114a-b. A user removable motor and controller box 112 is positioned between the base 110 having a pair of side supports 111a-b and the rotating bed platform 101 slowly rotate the platform from side-to-side causing a user to be continually repositioned during a sleep period.

The rotating bed/sleep/rest platform 101 that, rotates a person gently from side to side, helps to relieve the following problems commonly experienced on a flat or static mattress:
1) Back and joint soreness, bed sores, poor blood circulation, waking throughout the night to self-turn and other pressure induced health issues.
2) Digestion discomfort including gas pain and reflux.
3) Fabric lines pressed into skin from long periods of sleep in the same position.
4) Sleep apnea.
5) Autism Sleep Disorder.

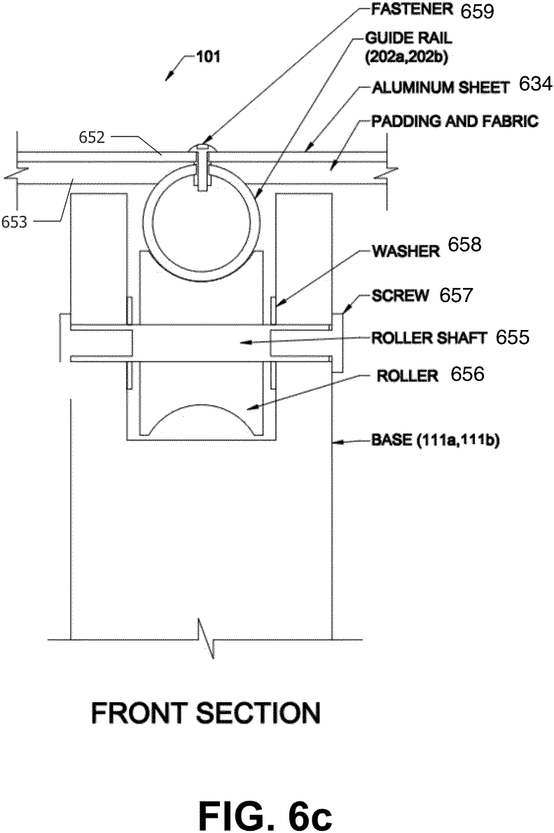

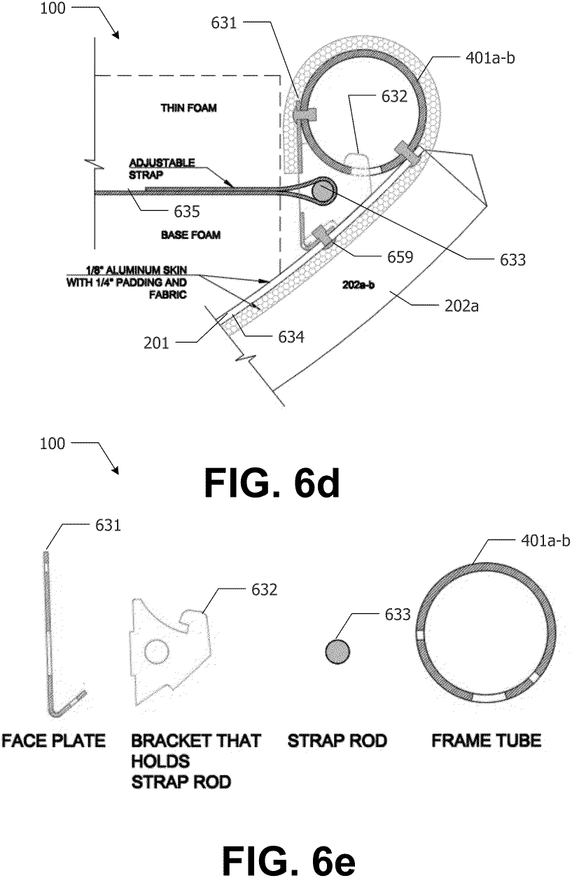

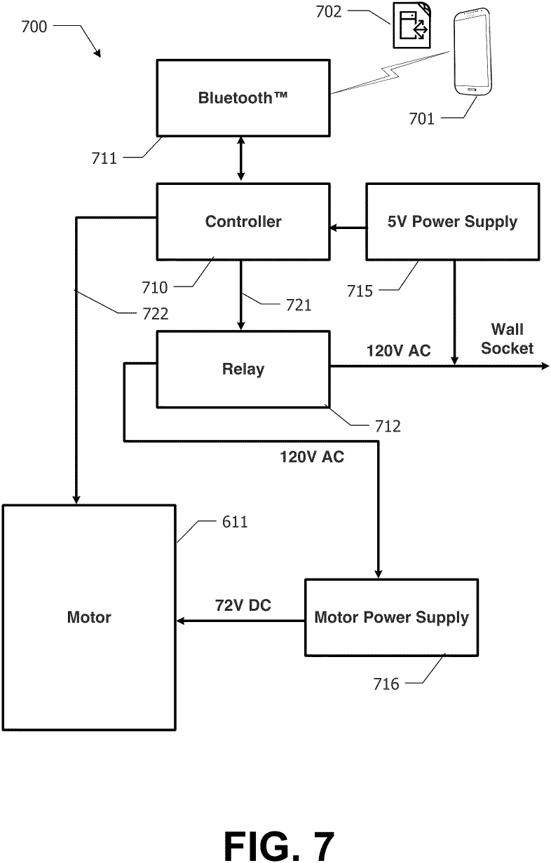

The rotating bed/sleep/rest platform 101 is rotated by an electrical motor 112 and related electronics 700 that is disclosed in detail in reference to FIGS. 6a-b and FIG. 7 respectively. The electronics 700 communicates wirelessly with a smartphone 701 that executes a mobile application 702 as disclosed in reference to FIG. 7.

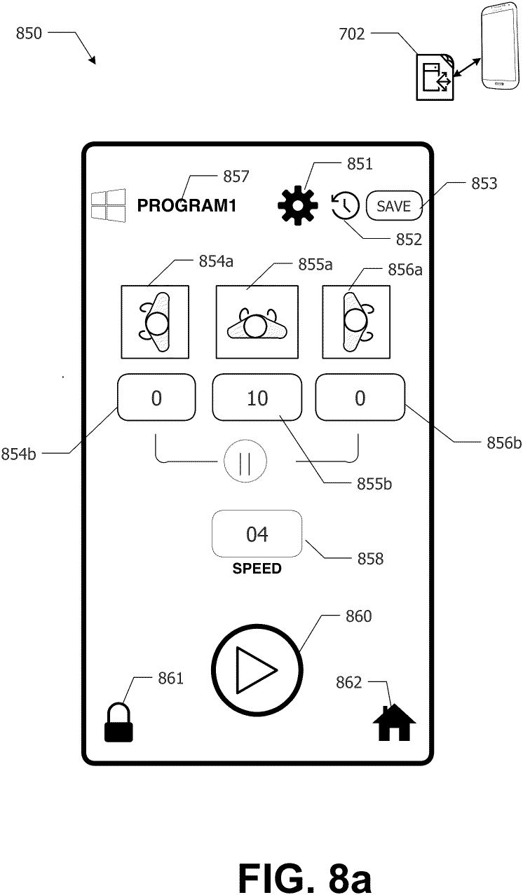

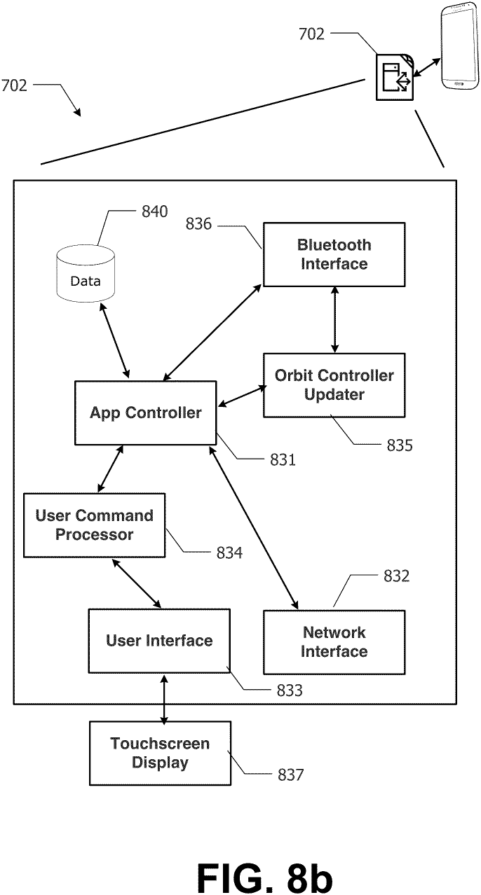

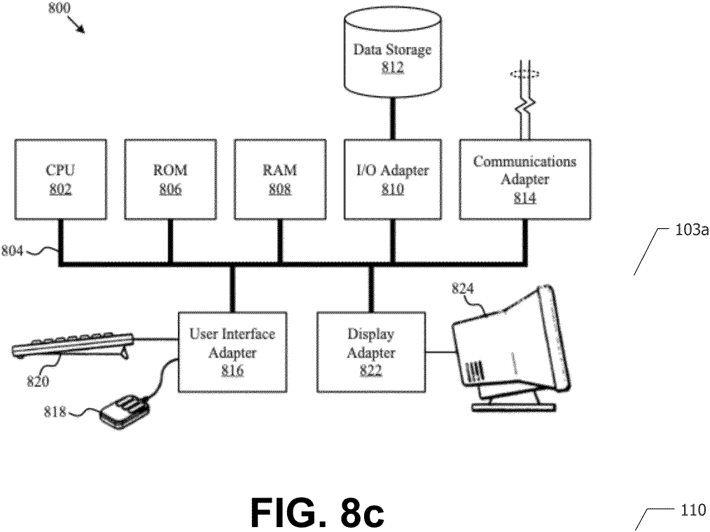

A set of user controls are provided by the mobile application 702 that is disclosed in reference to FIGS. 8a-c. The electronics 700 is electrically coupled to the motor 611 that controls the bed’s speed, positions, pauses at designated position times, and length of run time using a smartphone with the mobile app 702, wired remote, wireless remote, or mounted controls on the Orbit Concept bed 100. These controls are described below in more detail in reference to FIG. 8b.

A thin foam-based mattress 107 is set onto a set of straps/hammock 105 with a partial foam base underneath 106. When the user is in the side sleep position, he/she is lying on the thin foam 107 and thicker foam base 106. The thin foam base 107, as shown on FIG. 1, is held within the rotating bed/sleep/rest platform 101 by a set of straps 102a-b that run lengthwise across the thin foam base 107. When the user is in the back sleep position, he/she is lying on the thin foam 107 and cradled by the hammock 105. This hammock 105 allows for a gentle transition between side and back positions. The hammock 105 is adjustable to increase localized support, such as lumbar, as needed.

A user removable motor and controller box 112 is easily removed from the Orbit Concept bed 100 in order to be mailed back for repair if needed. The motor box 112 is powered by an AC electrical cord connected to a location electrical system. In a preferred embodiment, the motor itself is not currently user removable. The entire motor/controller box 112 is typically sent in for repair. The motor itself is powered by dc power.

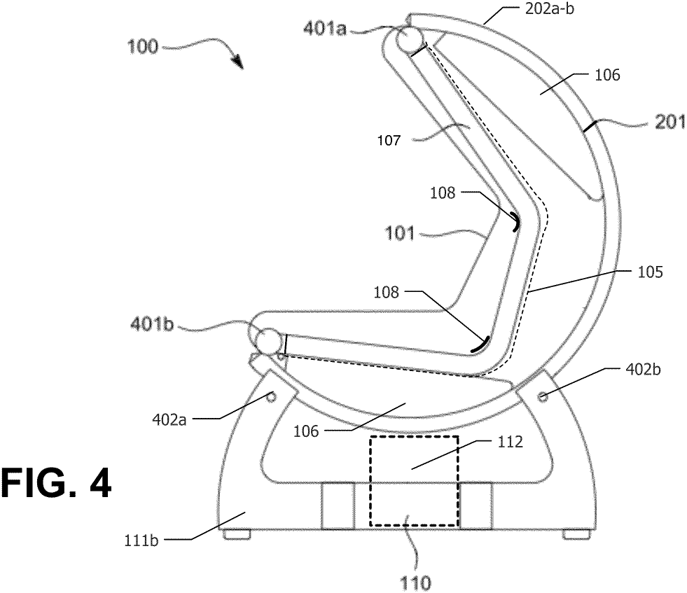

The aesthetic of the Orbit Concept bed 100 is designed to fit into a home without looking like a metal and plastic medical bed. It could also be used in medical facilities with a non-fabric covering to the upper bed frame. An aluminum skin version is currently covered by ¼” padding and fabric. As shown on FIG. 4, a ⅛” aluminum skin is between the guide rails and the 106 base foam. Narrow wood slats or other materials could be used instead of aluminum and a powder-coated metal base as well as locking wheels.

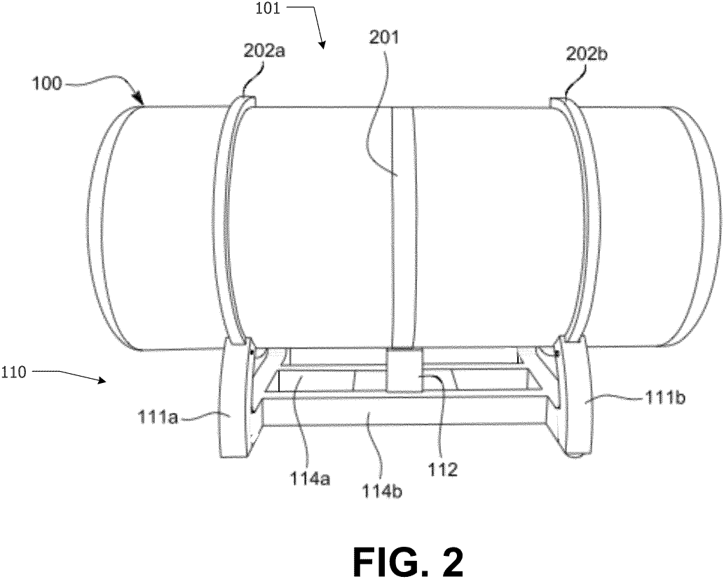

FIG. 2 illustrates a rear view of a system for providing an Orbit Sleep Concept Bed according to the present invention. A rear side of the rotating platform bed 101 has a center rotation strap 201 about its lengthwise center and a pair of side rotation rails 202a-b resting on the pair of side supports 111a-b of a base 110. When the motor 611 in the motor/controller box 112 is activated, the rotating motion is applied to the center rotation strap 201 and side rotation rails 202a-b to cause the rotating platform bed 101 to move back and forth across its range of motion. The rails 202a-b sit on the non-powered rollers of the side supports 111a-b. The rotation strap 201 holds the upper frame 101 to the base 110 which makes assembly easy.

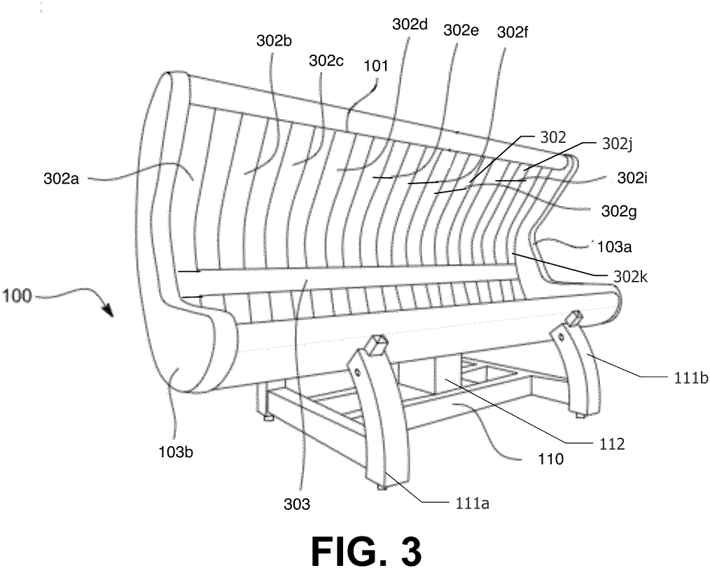

FIG. 3 illustrates a front, perspective view of a system for providing an Orbit Sleep Concept Bed according to the present invention. The straps/hammock 105 comprises a set of vertical straps 302a-k and one or more lengthwise straps 303 that are connected to the rotating platform bed 101 to support a user lying in the rotating platform bed 101. The set of vertical straps 302a-k and one or more lengthwise straps 303 are configured to rest below the thin foam-based mattress 107 and above the thick foam base 106. The straps are adjustable individually. There should be no contact between the user and the circular frame/structure of 101 underneath the straps when in back sleep position. When the rotating platform bed 101 rotates between each end of its range of rotation, the rotating platform bed 101 is sliding along the top surfaces of the pair of side supports 111a-b as controlled by the motor box 112.

FIG. 4 illustrates a cross section side view of a system for providing an Orbit Sleep Concept Bed according to the present invention. The Orbit Concept bed 100 is shown with the rotating platform bed 101, center rotation strap 201, and side rotation rails 202a-b resting on the pair of side supports 111a-b. The straps/hammock 105 is shown above the rotating platform bed 101 and the thick foam base 106 and below the thin foam base 107. The straps/hammock 105 connects to the rotating platform bed 101 by top and bottom connection rails 401a-b.

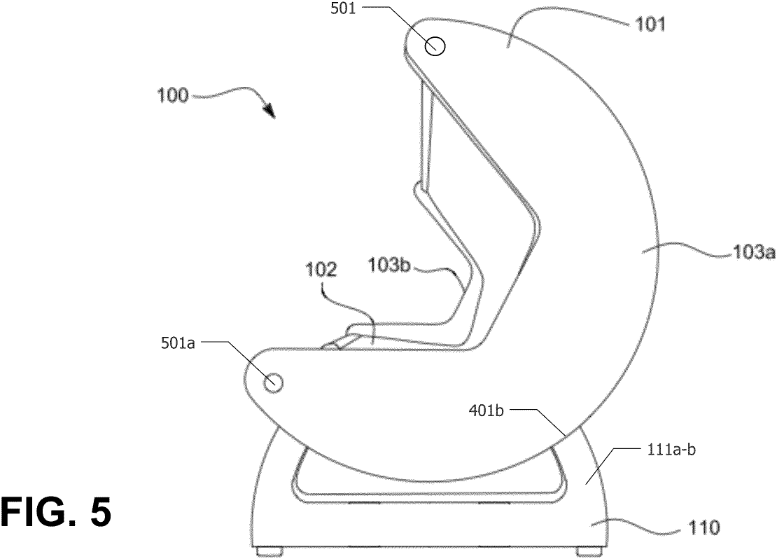

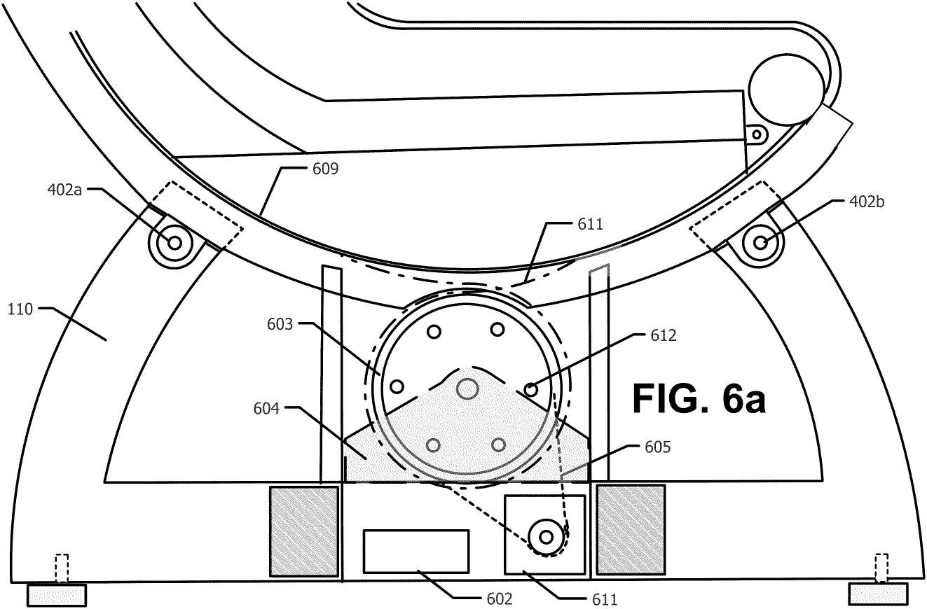

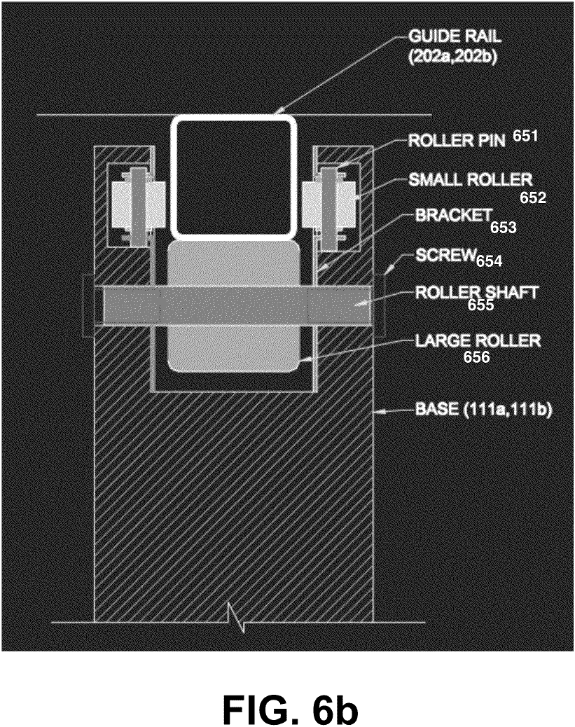

The base 110 is shown supporting the rotating platform bed 101 that rests on a set of roller supports 402a-b on each of the two side supports 111a-b. The user removable motor and controller box 112 is shown between the side supports 111a-b and connected to the center-strap 201 as disclosed below in reference to FIGS. 6a-b. Aluminum tubes 401a-b give structure to the long front edges that users sit on to get into the bed and are fastened to the guide rails 202a-b and the aluminum skin 634, as shown in FIG. 6c, that wraps around between the guide rails 202a-b and aluminum tubes 401a-b. The end enclosures 103a-b attach to the end of these tubes, as well as other points, by the visible connector 501 seen on FIG. 5 on the face of 103a and form the circular support for the thick base foam. FIG. 5 also shows an enclosing side 103a-b coupled to each end of the rotating platform bed 101 while resting on its base 110. As noted above, the rotating platform bed 101 rests on a set of roller supports 402a-b on each of the two side supports 111a-b.

FIGS. 6a-e illustrate the motor and roller components of a system for providing an Orbit Sleep Concept Bed according to the present invention. FIG. 6a shows a side view of the bed with the motor 611, its chain or belt 605 connected to a drive sprocket 603, and a drive strap 611. Also, there are roller assemblies 402a-b on the upper ends of the base where the guide rails travel. The roller assemblies 402a-b are on both ends of the bed. The motor 611 controls motion of the drive strap 201 that corresponds to the center strap. The center strap is coupled to the bed at the top and bottom edges with the strap otherwise being free so it can travel around the sprocket 603.

FIG. 6b shows a set of components used to construct the set of roller supports 402a-b. The roller assemblies 402a-b as shown in a FIG. 6a correspond to the roller assemblies at the top ends of each of the two base supports. Each roller assembly 402a-b comprise a roller shaft 655, a large roller 656, and a pair of smaller roller assemblies 651-653 located on either side of the guide rails 202a-b. Each of the smaller roller assemblies 651-653 comprise a small roller 652 supported by a bracket 653 and a roller pin 651. The small rollers 652 are used to guide sides of the rails 202a-b through the ends of the base 111a-b so the rails do not rub on the inside faces of base 111a-b and damage the rail finish. The guide rails 202a-b rest on the large rollers 656 and move along the rollers 656 when the drive strap 201 rotates about the sprocket 603 under control of the motor 611.

FIG. 6c shows another embodiment of the roller assemble 402a-b. The roller shaft 655 is coupled through the bed base 111a-b and secured by a screw 657 and washer 658. The large roller 656 is supported by the roller shaft 655 to support the guide rails 202a-b. A fastener 659 coupled the padded aluminum skin 634 to the aluminum tubes 401a-b.

FIG. 6d shows an end of the drive strap 201 connected to aluminum tubes 401a-b using the components shown individually in FIG. 6e. The components comprise a face plate 631, a support bracket 632, a strap rod 633, aluminum frame tube 401a-b, and padded aluminum skin 634. The padded aluminum skin 634 may be padded and covered in fabric and runs along the guide rails 202a-b and around the frame tubes 401a-b. The face plate 631 connects the aluminum tubes 401 a-b to the guide rails 202a-b at an inner end of the padded aluminum skin 634.

An adjustable strap 635, which corresponds to the straps 302a-k in FIG. 3, wraps around and terminates at the strap rod 633. The strap rod 633 is held in place by bracket 632 coupled to the aluminum tubes 401a-b on an inner side of the face plate 631.

FIG. 7 illustrates electrical components within the user removable motor and controller box of the system for providing an Orbit Sleep Concept Bed according to the present invention. The electrical components 700 are part of the user removable motor and controller box 112 and comprise a controller 710, a Bluetooth™ transceiver 711, a relay device 712, a 5V power supply 715, a motor power supply 716, and the motor 611.

The controller 710 is a programmable processing component that can store encoded data representing processing instructions. The controller 710 reads these instructions from memory and executes the instructions to implement the software components disclosed herein. The controller 710 is electrically coupled to the motor 611 and the relay device 712 to provide command signals controlling the operation of these devices, and ultimately the rotating platform bed 101.

The Bluetooth™ transceiver 711 generates radio frequency (RF) signals using the Bluetooth™ protocol to communicate with the mobile application 702 in the smartphone 701. The Bluetooth™ transceiver 711 uses the standard Bluetooth™ protocol to establish a connection, provide datalink security, perform data exchanges with the mobile application 702 to allow the mobile application to operate the functions of the rotating platform bed 101.

The relay device 712 electrically connects a 120V AC power source from a home electrical outlet (not shown) to power the operation of the motor 611. The relay device 712 receives a relay control signal 721 from the controller 710 to control the operation of the relay device 712. When the controller 710 activates the relay control signal 721, the relay device 712 closes an interconnection between the input 120V AC to the power input to the motor power supply 716. When the controller 710 deactivates the control signal 721, the relay device 712 opens and the motor power supply 716 is disconnected from the input power line to stop the operation of the motor 611.

The 5V power supply 715 provides a 5V DC power supply to power all of the internal electronics of the controller 710 and the Bluetooth™ transceiver 711. The 5V power supply 715 includes an AC-to DC converter configured to provide a 5V DC power source to the attached devices using energy received from the home AC power system.

The motor power supply 716 provides a 72V DC power supply to power all of the motor 611 of the rotating platform bed 101. The motor power supply 716 includes an AC-to DC converter configured to provide a 72V DC power source to the attached motor 611 using energy received from the home AC power system. The motor power supply 716 generates a power source as required to operate the motor 611. If in other embodiments, a motor is used that is powered by a different voltage, the motor power supply 716 would need to be configured to provide the needed voltage level.

The motor 611 rotates an attached spindle as disclosed above in reference to FIG. 6a to cause the rotating platform bed 101 to move from one position to another. The motor is powered by a 72V DC powerline generated by the motor power supply 716. The motor 611 also receives a set of motor control signals 722 from the controller 710 to activate the operation of the motor 611. In order for the motor to rotate the bed, the motor must receive both an active 72V DC powerline and the set of motor control signals 722 to operate. The motor control signals 722 comprises both a motor enables signal and a motor speed signal. The motor speed signal may comprise a DC voltage value that corresponds to a desired speed of the motor 611. The motor speed signal also may comprise an encoded set of signal values that corresponds to one of a plurality of desired speed of the motor 611.

FIGS. 8a-c illustrate a computing system for providing an Orbit Sleep Concept Bed including a set of software components, a mobile application, and a generalized schematic of a programmable processing system utilized as the various computing components described herein used to implement an embodiment of the present invention. FIG. 8a shows a user control screen 850 of the mobile application 702 for controlling the system for providing an Orbit Sleep Concept Bed according to the present invention.

On the user control screen 850 a set of user interface controls 851-862. The set of user interface controls 851-862 comprise settings control 851, timer control 852, save control 853, left position controls 854a-b, center position controls 855a-b, and right position controls 856a-b, a user defined program icon 857, a speed control 858, a run/pause/stop control 860, a lock mobile app control 861, and a home button control 862.

The settings control 851 presents a user with a set of controls that allows the user the ability to change preference values controlling the operation of the mobile application 702.

The timer control 852 presents a user with the ability to set a starting time, and ending time, and a length of operation of the rotating platform bed 101.

The save control 853 permits a user with an ability to save a particular set of set up parameters for operation of the rotating platform bed 101. Save control 853 saves the current set of values set within the mobile application 702 within a local datastore 840 for retrieval and use at a later date. The user may select the settings icon 851 to see a list of saved routines, create a new routine, edit a saved routine and to delete a routine.

The left position controls 854a-b defines the amount of time the rotating platform bed 101 is kept in the left most position. The left position icon 854a shows the orientation of a user when the rotating platform ben 101 is located at the left position. A time field 854b accepts a numerical input from the user that defines how long in minutes the rotating platform bed 101 remains in the left position before rotating to another position.

The center position controls 855a-b defines the amount of time the rotating platform bed 101 is kept in the center position. The center position icon 855a shows the orientation of a user on his or her back when the rotating platform bed 101 is located at the center position. A time field 855b accepts a numerical input from the user that defines how long in minutes the rotating platform bed 101 remains in the center position before rotating to another position.

The right position controls 856a-b defines the amount of time the rotating platform bed 101 is kept in the right most position. The right position icon 856a shows the orientation of a user rotating platform bed 101 is located at the right position. A time field 856b accepts a when the numerical input from the user that defines how long in minutes the rotating platform bed 101 remains in the right position before rotating to another position.

The user defined program icon 857 identifies the user provided program name for a program currently in operation. The user provided program name corresponds to a name entered when a program of settings is saved by a user for retrieval and use at a later date.

The speed control 858 defines the rotational speed of the rotating platform bed 101 is moving between positions. A speed field 858 accepts a numerical input from the user that defines a rate of rotation using a scale of speeds between 0 and 10. In a preferred embodiment, the speed value scale may be created by simply taking the minimum and maximum permanently set speeds and dividing that range by 10.

The run/pause/stop control 860 accepts input from the user to change the operation of the rotating platform bed 101 as defined by the set of user interface controls 851-862. The user pressing upon the run/pause/stop control 860 changes the operation between running using the settings of the mobile application, pausing the operation of the rotating platform bed 101, and terminating the running of the rotating platform bed 101. Placing the mobile application 702 into a stop state will terminate all timers used within the current operation of the rotating platform bed 101. In contrast, the pause state merely stops the operation in its current state and will resume the paused program when pressed again.

The lock mobile app control 861 locks the app controls on the mobile application 702 from accepting input from a user until the lock is removed. The user may hold the lock mobile app control 861 for 3 seconds to lock all controls except for the run, pause, stop button 860.

The home button control 862 returns the bed to the start position so the user can easily get out of the bed. The start position is user defined in the settings as to be left or right side of the bed being down in a position permitting a user to enter and exit the bed.

From the app screen of the functions there are three positions corresponding to the length of time spent at each position. In this embodiment, there are only 3 points where bed rotation is stopped. The distance to the right and left side can be user adjusted in the settings. This setting is separate from the “return” function which brings the position of the bed back to start for getting out. The digits under the positions indicate how long the bed is in that position before it moves on to the next position. In a preferred embodiment, different patterns possible for the positions i.e. Left ------> Center -----> Right ------> Center ------> Left or Right -------> Center ------> Left ------> Center ------> Right depending upon which side a user sets as a first orientation. Additional rotation patterns such as a round robin order where one change will go from Left —> Right or Right —> Left or other programmed sequences of positions.

The starting position for any sequence is important due to the position of the bed in a room and which side is facing out towards the center of the room. The starting position is typically the end positions of Left or Right to orient the rotating bed 101 into a position permitting a user to get into the bed. If only one of the positions is selected, then the bed will move from the starting side position to the selected position and stay there. A user cannot select left and right without the center being selected as the bed obviously cannot go from left to right without crossing center.

FIG. 8b shows a computing system of software components 831-840 for providing an Orbit Sleep Concept Bed according to the present invention. The software components 831-840 of the mobile app 702 comprise an app controller 831, a network interface 832, a Bluetooth™ interface 836, a user interface 833 coupled to a touch screen display 837, a user command processor 834, and local datastore 840.

The app controller 831 acts as a central overall controller for the set of software components 831-840. User commands from the user interface 833 are received and processed by the user command processor component 834 to determine actions to be taken, and then mobile app commands are passed to the other software components 831-840, as needed, to implement the actions to be taken. The app controller 831 also works with the Bluetooth™ interface.

The network interface 832 permits mobile application 702 to communicate with remote computing devices including a web server (not shown). The mobile application 702 may download updates to the controls for the rotating platform bed 101 and also may upload performance and maintenance information to a manufacturer web site permitting the monitoring and repairing of the rotating platform bed 101 and its performance and usage. The network interface 832 performs all of the data formatting, computer to computer communications, encryption processing, and all similar operations needed by the web server to communicate with users.

The Bluetooth interface 836 permits mobile application 702 to communicate with the user removable motor and controller box 112 of the rotating platform bed 101. The Bluetooth™ interface 836 performs all of the device paring and session connection, data formatting, computer to computer communications, encryption processing, and all similar operations needed by the mobile application 702 to communicate with the user removable motor and controller box 112.

The user interface 833 coupled to a touch screen display 837 provides input and output processing to provide a user with controls and data needed to operate the rotating platform bed 101 and all of its functions. This interface module 834 also accepts commands from the user to instruct the application to perform these tasks via the touch screen display 837.

The user command processor 835 receives user input data from the user interface 834 to decode the received data, to identify a command to perform, and to communicate with other software components 831-840 causing the user command to be performed. The user command processor 835 offloads the processing of user commands from other communications and control functions performed by the app controller 831.

The local datastore 840 provides a local data storage location within the memory of the mobile application, that may be maintained by the smartphone 701, for all of the software components 831-837. The software components 831-837 may store data within the local datastore 840 and may retrieved saved data from the local datastore 840 when needed.

FIG. 8c illustrates a generalized schematic of a programmable processing system utilized as the various computing components described herein used to implement an embodiment of the present invention. The controller 710 may be implemented as a digital processing system 800 that contains software in the form of executable instructions stored within memory of the system controller 112. When the CPU 802 executes these instructions in memory, the system controller 112 performs the functions of the system 100 as described herein.

The CPU 802 is coupled to the system bus 804. The CPU 802 may be a general-purpose CPU or microprocessor, graphics processing unit (“GPU”), and/or microcontroller. The present embodiments are not restricted by the architecture of the CPU 802 so long as the CPU 802, whether directly or indirectly, supports the operations as described herein. The CPU 802 may execute the various logical instructions according to the present embodiments.

The computer system 800 also may include random access memory (RAM) 808, which may be synchronous RAM (SRAM), dynamic RAM (DRAM), synchronous dynamic RAM (SDRAM), or the like. The computer system 800 may utilize RAM 808 to store the various data structures used by a software application. The computer system 800 also may include read only memory (ROM) 806 which may be PROM, EPROM, EEPROM, optical storage, or the like. The ROM may store configuration information for booting the computer system 800. The RAM 808 and the ROM 806 hold user and system data, and both the RAM 808 and the ROM 806 may be randomly accessed.

The computer system 800 also may include an input/output (I/O) adapter 810, a communications adapter 814, a user interface adapter 816, and a display adapter 822. The I/O adapter 810 and/or the user interface adapter 816 may, in certain embodiments, enable a user to interact with the computer system 800. In a further embodiment, the display adapter 822 may display a graphical user interface (GUI) associated with a software or web-based application on a display device 824, such as a monitor or touch screen.

The I/O adapter 810 may couple one or more storage devices 812, such as one or more of a hard drive, a solid-state storage device, a flash drive, a compact disc (CD) drive, to the computer system 800. According to one embodiment, the data storage 812 may be a separate server coupled to the computer system 800 through a network connection to the I/O adapter 810. The communications adapter 814 may be adapted to couple the computer system 800 to the network 808, which may be one or more of a LAN, WAN, and/or the Internet. The communications adapter 814 may also be adapted to couple the computer system 800 to other networks such as a global positioning system (GPS) or a Bluetooth network. The user interface adapter 816 couples user input devices, such as a keyboard 820, a pointing device 818, and/or a touch screen (not shown) to the computer system 800. The keyboard 820 may be an on-screen keyboard displayed on a touch panel. Additional devices (not shown) such as a camera, microphone, video camera, accelerometer, compass, and or gyroscope may be coupled to the user interface adapter 816. The display adapter 822 may be driven by the CPU 802 to control the display on the display device 824. Any of the devices 802-822 may be physical and/or logical.

The applications of the present disclosure are not limited to the architecture of the computer system 800. Rather the computer system 800 is provided as an example of one type of computing device that may be adapted to perform the functions of an Orbit Sleep Concept Bed, including servers, personal computers, and mobile devices as shown in FIG. 3. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 800 may be virtualized for access by multiple users and/or applications.

Additionally, the embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention. This written description provides an illustrative explanation and/or account of the present invention. It may be possible to deliver equivalent benefits using variations of the specific embodiments, without departing from the inventive concept. This description and these drawings, therefore, are to be regarded as illustrative and not restrictive.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. A system for providing an Orbit Sleep Concept Bed, the system comprising:
a rotating bed platform for slowly rotating from side to side to continually reposition during a sleep period;
a motor and controller box coupled to the rotating bed platform for rotating the bed platform from side to side to continually reposition during a sleep period; and
a base having a pair of side supports and connecting side members supporting the rotating bed.

2. The system according to claim 1, wherein the rotating bed platform comprises:
a platform bed;
a top and bottom connection rails running along a length of the platform bed;
a set of strap/hammock about an inner side of the platform bed;
a thin foam mattress having a thin foam base and a partial foam base;
a pair of guide rails along an outer side of the platform bed, each of the pair of guide rails resting upon a set of roller supports coupled to each end of the side supports of the base; and
a drive strap coupled to top and bottom rails and engaging the motor and controller box to move the platform bed.

3. The system according to claim 2, wherein the motor and controller box comprises:
a motor coupled to a spindle by a drive line, the drive strap being configured around the spindle such that rotation caused by the motor causes the drive strap to rotate the bed platform; and
a set of electrical components comprising:
a programmable controller;
a Bluetooth transceiver;
a power supply;
a motor power supply; and
a relay device for controllably connecting the motor power supply to the motor.

4. The system according to claim 3, wherein the programmable controller comprises:
a memory having instructions stored thereon; and
a processor configured to execute a set of software components on the memory to cause the programmable controller to rotate the bed platform according to a user defined program, the set of software components comprise:
an app controller;
a network interface;
a Bluetooth™ interface communicatively connected to the Bluetooth transceiver;
a user interface coupled to a touch screen display,
a user command processor; and
a local datastore.

5. The system according to claim 3, wherein the motor is powered by a powerline generated by the motor power supply and also receives a set of motor control signals from the programmable controller to activate the operation of the motor; and
the motor must receive both an active powerline and the set of motor control signals to operate, the motor control signals comprises both a motor enable signal and a motor speed signal.

6. The system according to claim 5, wherein the motor speed signal comprises a DC voltage value that corresponds to a desired speed of the motor.

7. The system according to claim 5, wherein the motor speed signal comprises an encoded set of signal values that corresponds to one of a plurality of desired speed of the motor.

8. The system according to claim 5, wherein the programmable controller causes the platform bed to rotate between a left position, a right position, and a center position, the programmable controller causes the platform bed to pause at each of the left position, the right position, and the center position for a corresponding delay period of time before moving to a next position.

9. The system according to claim 8, wherein the left position uses a left delay time period, the right position uses a right delay time period, and the center position uses a center delay time period.

10. The system according to claim 8, wherein a smartphone coupled to the programmable controller via a Bluetooth connection to permit a user program the user program defines the sequence of positions that the bed platform rotates to before each delay time period, the left position, the left delay time period, the right position, a right delay time period, the center position, the center delay time period, and a speed of rotation.

11. A method for providing an Orbit Sleep Concept Bed, the Orbit Sleep Concept Bed having a rotating bed platform for slowly rotating from side to side to continually reposition during a sleep period, a motor and controller box coupled to the rotating bed platform for rotating the bed platform from side to side to continually reposition during a sleep period, and a base having a pair of side supports and connecting side members supporting the rotating bed, the method comprising:
accepting a user program defining the sequence of positions that the bed platform rotates to before a delay time period;
rotating the bed platform to a first position of the user program;
waiting the delay time period;
rotating the bed platform to a next position of the user program until the user program ends.

12. The method according to claim 11, wherein the user program further defines a left position, a left delay time period, a right position, a right delay time period, a center position, a center delay time period, and a speed of rotation.

13. The method according to claim 12, wherein rotating bed platform comprises:
a platform bed;
a top and bottom connection rails running along a length of the platform bed;
a set of strap/hammock about an inner side of the platform bed;
a thin foam mattress having a thin foam base and a partial foam base;
a pair of guide rails along an outer side of the platform bed, each of the pair of guide rails resting upon a set of roller supports coupled to each end of the side supports of the base; and
a drive strap coupled to top and bottom rails and engaging the motor and controller box to move the platform bed.

14. The method according to claim 13, wherein the programmable controller comprises:
a memory having instructions stored thereon; and
a processor configured to execute a set of software components on the memory to cause the programmable controller to rotate the bed platform according to a user defined program, the set of software components comprise:
an app controller;
a network interface;
a Bluetooth™ interface communicatively connected to the Bluetooth transceiver;
a user interface coupled to a touch screen display,
a user command processor; and
a local datastore.

15. The method according to claim 14, wherein the motor is powered by a powerline generated by the motor power supply and also receives a set of motor control signals from the programmable controller to activate the operation of the motor; and
the motor must receive both an active powerline and the set of motor control signals to operate, the motor control signals comprises both a motor enable signal and a motor speed signal.

16. The method according to claim 15, wherein the motor speed signal comprises a DC voltage value that corresponds to a desired speed of the motor.

17. The method according to claim 15, wherein the motor speed signal comprises an encoded set of signal values that corresponds to one of a plurality of desired speed of the motor.

18. The system according to claim 15, wherein a smartphone coupled to the programmable controller via a Bluetooth connection to permit a user program the user program defines the sequence of positions that the bed platform rotates to before each delay time period, the left position, the left delay time period, the right position, a right delay time period, the center position, the center delay time period, and a speed of rotation.
